(19) United States
(12) Patent Application Publication
(10) Pub. No.: US 2009/0195904 A1
(43) Pub. Date: Aug. 6, 2009

(54) MAGNETIC ROM INFORMATION CARRIER

(75) Inventors: Jaap Ruigrok, Asten (NL); Marcello L., M. Balistreri, Rosmalen (NL); Antonius E., T. Kuiper, Maarheeze (NL); Michel M., J. Decre, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/996,308

(22) PCT Filed: Jul. 13, 2006
(86) PCT No.: PCT/IB06/52386

§ 371 Date: Nov. 14, 2008

(30) Foreign Application Priority Data
Jul. 21, 2005 (EP) 05106696.7

(51) Int. Cl. G11B 5/02; G11B 5/84

(52) U.S. Cl. 360/55; 427/548; G9B/5.026

(57) ABSTRACT

The invention relates to a method of manufacturing a device (10) comprising a layer (12) having a pattern of disjunct portions (14) of magnetic material (18) generating a corresponding pattern of local magnetic fields (2). The magnetic material (18) is constituted of particles (22) dispersed in a solid substance (24). The particles are magnetically stable and substantially aligned for generating the local magnetic fields (2). The method comprises the steps of: providing a substance (32) having the particles (22) dispersed in the substance (32), the substance (32) having a viscosity for allowing the particles (22) to move in the substance (32), creating the pattern of disjunct portions (14) of the substance (32) in the layer (12) of the device (10), applying an external magnetic field (50) for substantially aligning the particles (22) in the disjunct portions (14) of the substance (32), and solidifying the substance (32) for obtaining the solid substance (24). The benefit of this method is that instead of changing the magnetization inside the particles (22), the particles (22) are moved, typically rotated, to be aligned to the externally applied magnetic field (50). Subsequent solidification of the substance (32) fixes the aligned magnetically stable particles (22) inside the solid substance (24) which results in a permanently magnetized magnetic material (18).

The invention relates to a method of manufacturing a device comprising a layer having a pattern of disjunct portions of magnetic material generating a corresponding pattern of local magnetic fields.

The invention further relates to a device.

A continuous layer of magnetic material typically generates a macroscopic magnetic field extending outside the continuous layer of the magnetic material. In a layer having disjunct portions of magnetic material each portion is separate from other disjunct portions inside the layer and therefore generates a magnetic field which locally extends outside the layer of disjunct portions. A disjunct portion may be formed, for example, by a protrusion from a continuous layer of magnetic material or, for example, may be an isolated portion of magnetic material inside the layer.

In a magnetic ROM information carrier isolated bits may be formed by disjunct portions of magnetic material in which the information stored on the information carrier is represented by the pattern of local magnetic fields corresponding to the pattern of disjunct portions. Such a magnetic ROM information carrier, for example, is disclosed in WO 2004/032149. In this document a storage device is disclosed comprising an information carrier part and a read-out part. The information carrier part comprises an information plane for cooperating with a read-out part. The information plane comprises a pattern of electro-magnetic material which constitutes an array of bit locations. The presence or absence of electromagnetic material at the information plane represents a logical value. In a first bit location the material is present, for example, indicating the logical value 1, and in a second bit location the material is absent, for example, indicating the logical value 0. In a specific embodiment of the disclosed information carrier, the electromagnetic material which represents a bit at a bit location is an isolated bit of hard magnetic material. The pattern of isolated bits of hard magnetic material is permanently magnetized in an external magnetic field, creating a pattern of magnetized magnetic bits all substantially having the same magnetic field direction comprising a magnetic field strength. The read-out part comprises electromagnetic sensor elements which are sensitive to the presence of said electromagnetic material. The read-out is done via a resistance measurement which relies on a magnetoresistance phenomenon. The resistance in the sensor element is influenced by a nearby magnetic field. At a bit location of the information carrier part where a magnetized bit is present, the magnetic bit provides a magnetic field substantially having the magnetic field direction and the magnetic field strength to the sensor element resulting in a first sensed resistance. At a bit location of the information carrier part where no magnetic bit is present, the sensor element senses a different magnetic field strength, resulting in a second sensed resistance, which is different from the first sensed resistance. When measuring the resistance of the sensor element at each of the bit locations, the logical value of each of the bit locations can be determined.

A drawback of the known read only magnetic information carriers is that the pattern of hard magnetic material must be magnetized during manufacturing, which typically requires strong magnetic fields.

It is an object of the invention to provide a method of manufacturing a device comprising a pattern of magnetic material which can be magnetized relatively easily.

According to a first aspect of the invention the object is achieved with a method of manufacturing a device as defined in the opening paragraph, wherein the magnetic material is constituted of particles dispersed in a solid substance, the particles being magnetically stable and substantially aligned for generating the local magnetic fields, the method comprising the steps of: providing a substance having the particles dispersed in the substance, the substance having a viscosity for allowing the particles to move in the substance, creating the pattern of disjunct portions of the substance in the layer of the device, applying an external magnetic field for substantially aligning the particles in the disjunct portions of the substance, and solidifying the substance for obtaining the solid substance.

The magnetic material is constituted of substantially isolated particles which are spread in the substance. The particles each generate particle magnetic fields which are aligned. Due to the alignment, the particle magnetic fields of the particles inside the disjunct portion add up to generate the local magnetic field emerging from the disjunct portion. The particles are magnetically stable which secures the magnetization direction within the particles and prevents the magnetization direction of the particles from randomly changing. The solidification of the substance secures the particles to maintain the alignment of the particles inside the disjunct portion.

The effect of the measures according to the invention is that the applied substance has a viscosity which allows the particles dispersed in the substance to move. In the method of manufacturing the particles are aligned using an external magnetic field. Due to the ability of the particles to move inside the substance, only a relatively weak externally applied magnetic field is required to mechanically move the particles and align the particles inside the substrate. Subsequent solidification of the substance fixes the aligned magnetically stable particles within the solid substance which results in a permanently magnetized magnetic material. Instead of changing the magnetization of the particles which typically requires a relatively strong externally applied magnetic field, the particles mechanically move inside the substance due to their relatively good mobility and, for example, rotate to align the particle magnetic field to the externally applied magnetic field. The strength of the externally applied magnetic field to achieve alignment of the particles typically depends on the mobility of the particles inside the substance.

The mechanical movement of the particle due to the externally applied magnetic field typically comprises a rotation of the particle to align the particle to the externally applied magnetic field. In embodiments in which the externally applied magnetic field comprises a magnetic field gradient the mechanical movement also comprises a migration of the particle along the gradient.

The applied substance can, for example, be hot melted solid substance to obtain increased mobility of the particles during magnetization and subsequently cooling down to fix the aligned particles in the solid substance. Alternatively, a chemical composition of the substance can be changed after magnetization, for example, polymerizing a magnetized monomer substance to obtain a solid polymer.

An additional benefit of the method of manufacturing according to the invention is that the method of manufacturing enables the use of well known manufacturing processes for creating the pattern of disjunct portions. The required viscosity of the substance for allowing the particles to move in the substance typically allows the use of manufacturing processes like embossing or stamping for creating the pattern of disjunct portions in the layer.

The invention is based on the recognition that the stability of a magnetic particle depends on a barrier energy. The barrier energy defines an energy level which must be overcome using, for example, an external magnetic field, to change the magnetization direction of the magnetic bit. The barrier energy typically depends on a volume of the magnetic particle and on the magnetic anisotropy energy density of the magnetic particle. Reducing the volume of the magnetic particle also reduces the barrier energy. When the barrier energy approaches a thermal energy of the material, the magnetization direction of the magnetic particle becomes unstable which results in a random change of the magnetization direction of the magnetic particle. Applying magnetic particles constituted of magnetic material which comprises a relatively high magnetic anisotropy energy density increases the stability of the magnetic particle, but also requires a relatively strong magnetic field for setting the magnetization direction inside the magnetic particle. In the method of manufacturing the device according to the current invention magnetic material is magnetized by mechanically aligning the magnetically stable particles dispersed in the substance rather than by altering the magnetization direction inside the particles. When the mobility of the magnetic particles is high, material having high magnetic anisotropy energy density can be applied in the particles while still a relatively weak externally applied magnetic field is sufficient for magnetization.

According to a second aspect of the invention the object is achieved with a device as defined in the opening paragraph, wherein the magnetic material being constituted of particles dispersed in a solid substance, the particles being magnetically stable and substantially aligned for generating the local magnetic fields. Magnetic material constituted of particles dispersed in a solid substance typically is easier to manufacture and process compared to conventional magnetic materials which makes the magnetic device according to the invention typically less expensive than conventional magnetic device.

In an embodiment of the method the step of applying the external magnetic field is performed during the step of solidifying the substance. A benefit of this embodiment is that the presence of the external magnetic field during solidification ensures that the particles remain aligned during the solidification of the substance optimizing the contributions of each particle magnetic field to the pattern of local magnetic fields.

In an embodiment of the method the step of applying the external magnetic field comprises creating spatial magnetic field strength variations in the external magnetic field. Due to spatial magnetic field strength variations the magnetic field can, for example, be focused at the disjunct portions. This enables a further reduction of the overall field strength of the externally applied magnetic field while maintaining a sufficiently strong magnetic field at the disjunct portions for aligning the particles.

In an embodiment of the method the step of applying the external magnetic field is performed during the step of creating the pattern of disjunct portions and wherein the step of creating the pattern of disjunct portions comprises utilizing a stamp for creating the pattern of disjunct portions, the stamp comprising magnetically permeable material for creating the spatial magnetic field strength variations. Magnetically permeable material gathers magnetic lines of force. When magnetically permeable material is brought in a homogeneous magnetic field, the gathering of magnetic lines of force will introduce an increased concentration of the magnetic lines of force at the magnetically permeable material, creating spatial magnetic field strength variations.

In an embodiment of the method the magnetically permeable material of the stamp is arranged in a stamp-pattern corresponding to the pattern of disjunct portions. A benefit of this embodiment is that when the external magnetic field is applied while the stamp creates the pattern of disjunct portions, the magnetically permeable material will gather magnetic lines of force and create spatial magnetic field strength variations which correspond to the pattern of disjunct portions, increasing the magnetic field strength at the disjunct portions and reducing the magnetic field strength outside the disjunct portions. Next to enabling a reduction of the overall field strength of the externally applied magnetic field, these field strength variations typically result in a magnetic field gradient which results in a migration of the particles along the gradient creating concentration difference of the particles in the substance. Magnetized particles tend to maximize their magnetic flux and, depending on the mobility of the particles, migrate to regions in which the magnetic field is stronger. The concentration differences of the particles in the device result in differences in the magnetic field strength of the local magnetic fields. After the fixation of the particles and removal of the external magnetic field, the concentration variations of the particles results in a field-strength variation of the local magnetic fields in the device.

In an embodiment of the method the magnetically permeable material of the stamp is arranged in protrusions emerging from the stamp and being arranged in a negative stamp-pattern for creating the pattern of disjunct portions. The negative stamp-pattern is a pattern of protrusions emerging from the stamp which, when applied to a substance, creates the pattern of disjunct portions in the substance. A benefit of this embodiment is that when the external magnetic field is applied while the stamp creates the pattern of disjunct portion, the magnetically permeable material in the protrusions will create spatial magnetic field strength variations and concentrate the external magnetic field in the layer of disjunct portions. Also in this embodiment migration of the particles toward the disjunct portions may occur, depending on the mobility of the particles dispersed in the substance.

In an embodiment of the method the step of providing the substance comprises providing the substance in a continuous layer and wherein the step of creating the pattern of disjunct portions comprises creating protrusions from the continuous layer, the protrusions being the disjunct portions. A benefit of this embodiment is that the substance and the pattern of disjunct portions can be applied relatively easily. The substance, for example, can be applied via spin-coating and the pattern can subsequently be applied via stamping the pattern, creating the pattern of protrusions from the continuous layer.

In an embodiment of the device, the particles are constituted of material having a magnetic anisotropy energy density of at least 100 kilo-Joules per cubic meter and preferably above 400 kilo-Joules per cubic meter. The barrier energy associated with particles being constituted of material having a magnetic anisotropy energy density above 100 kilo-Joules per cubic meter typically remains large enough to ensure magnetic stability of the magnetization direction of the particle, even at relatively small dimensions of the particles. Materials having a magnetic anisotropy energy density above 400 kilo-Joules per cubic meter enable a further reduction of the dimensions of the particles. Although these materials are very difficult to magnetize, the proposed device enables a magnetization of the particles using a relatively weak externally applied magnetic field.

In an embodiment of the device, the local magnetic fields substantially all have a same magnetic field direction. The pattern of disjunct magnetic material typically comprises a pattern of magnetic field strength variations which can be sensed by a sensor. The pattern of magnetic field strength variations may, for example, represent information stored on the device.

In an embodiment of the device, the solid substance is a polymer. A benefit when using the polymer is that a broad range of manufacturing methods well known to a skilled person may be employed. A further benefit when using a polymer is that the polymer is produced from a monomer typically having a low viscosity. Particles suspended in the monomer typically can move relatively freely and therefore can be aligned using a relatively weak external magnetic field. Subsequent polymerization of the monomer, preferably while the externally applied magnetic field is present, results in a permanently magnetized polymer.

These and other aspects of the invention are apparent from and will be elucidated with reference to the embodiments described hereinafter.

In the drawings:

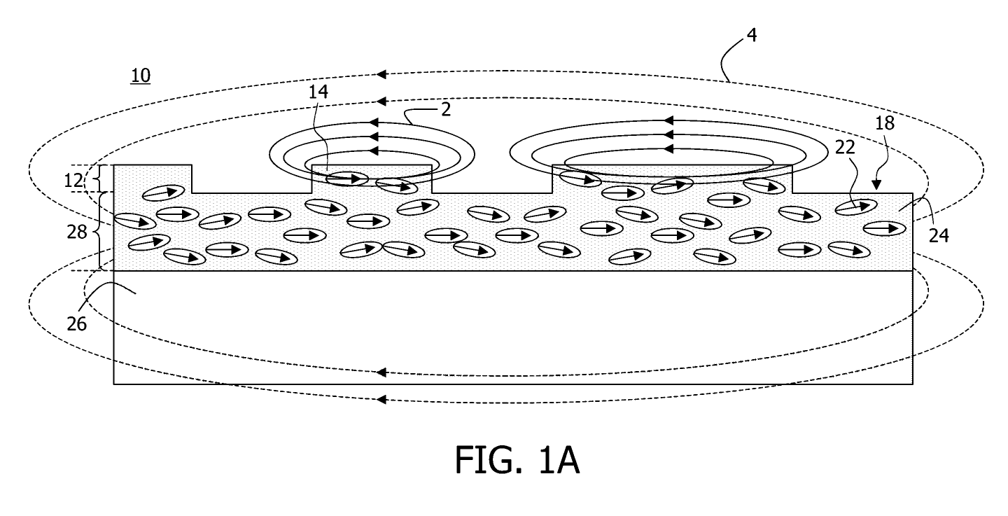

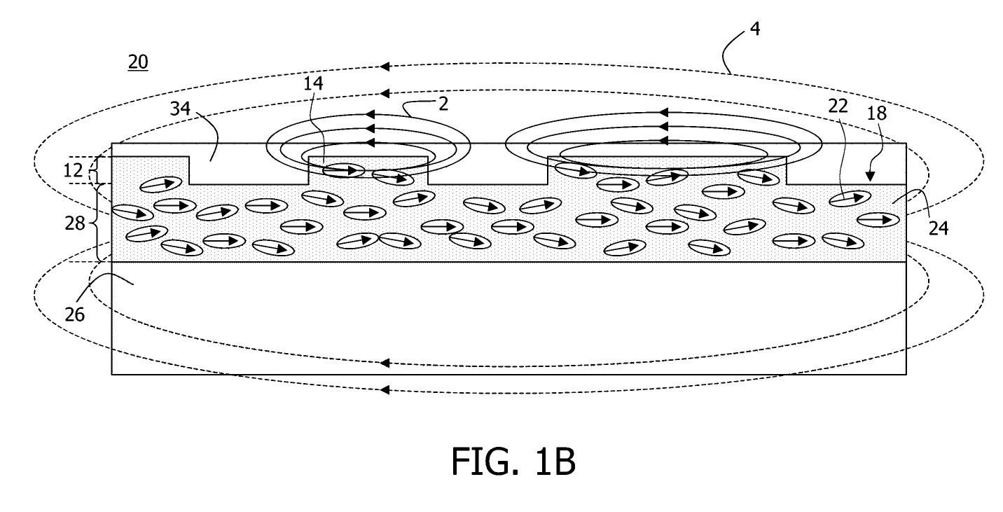

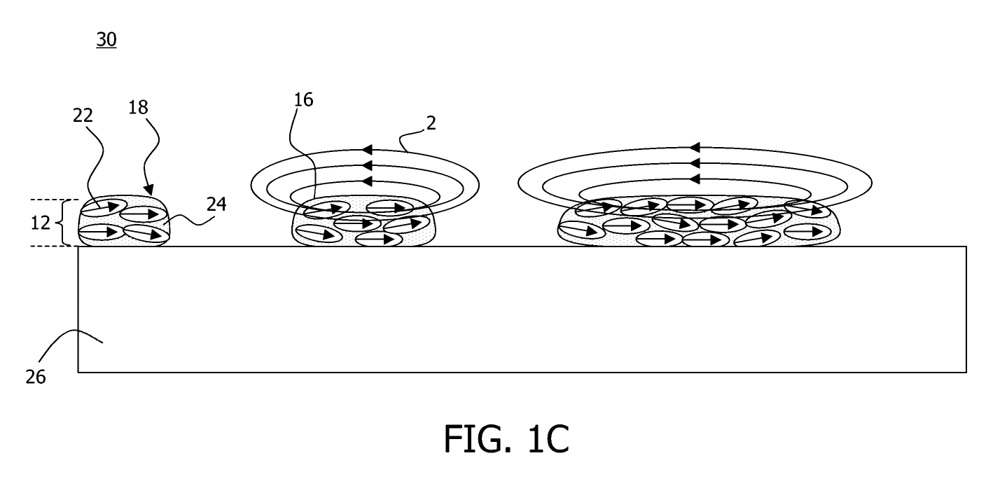

FIGS. 1A to 1C show embodiments of the device according to the invention,

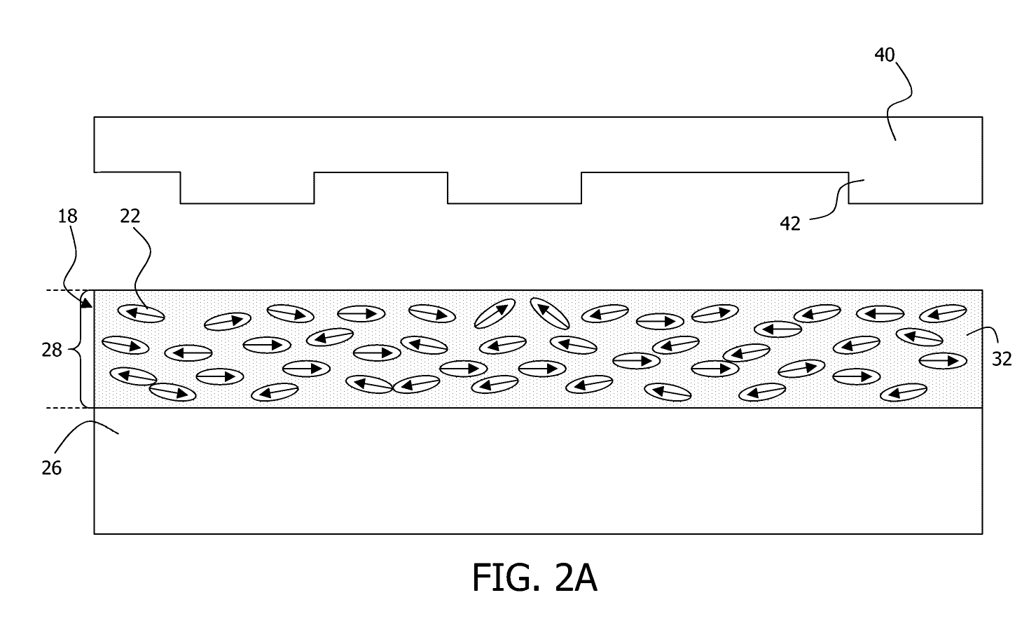

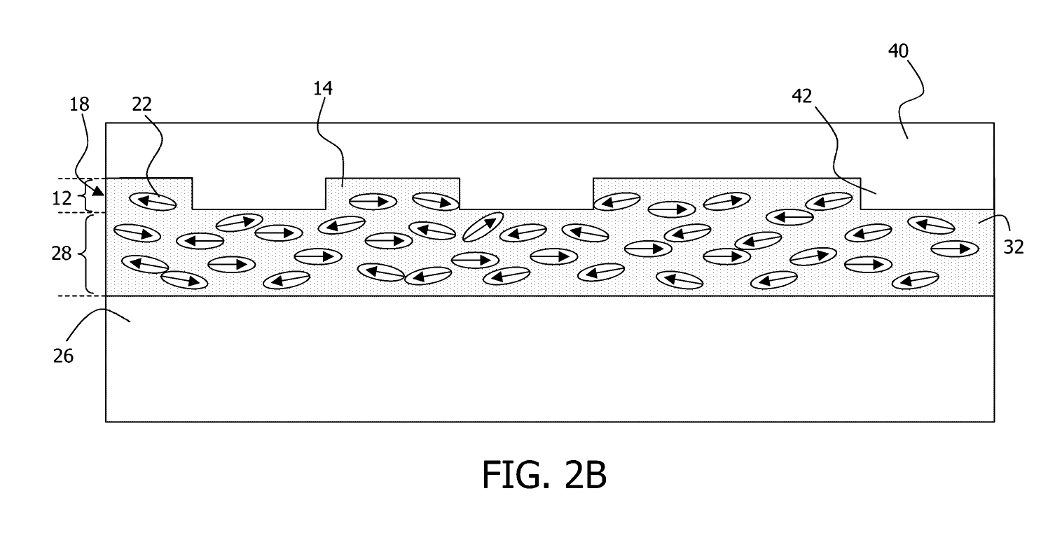

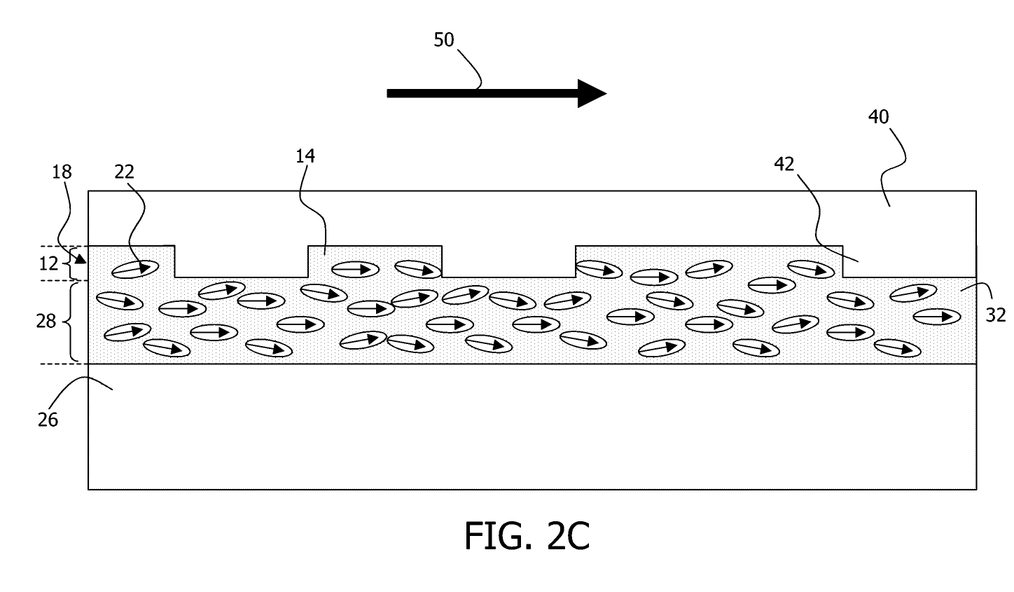

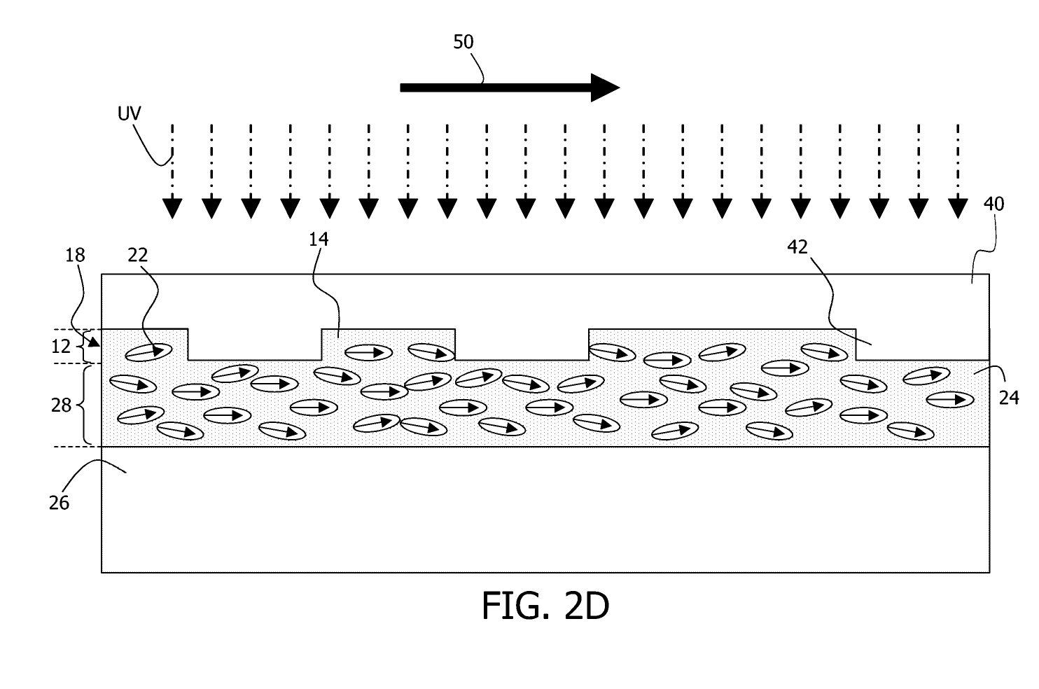

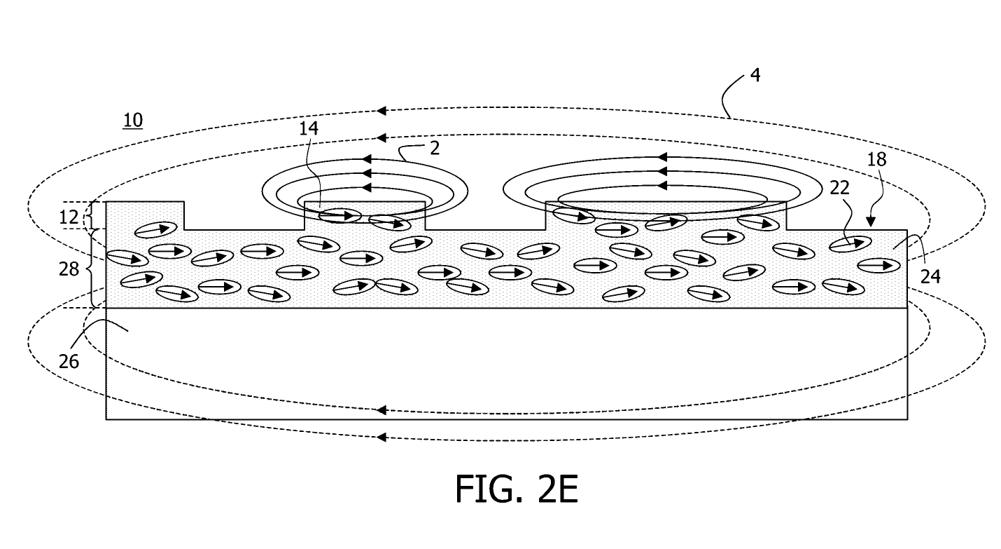

FIGS. 2A to 2E show several steps in a method of manufacturing the device according to the invention,

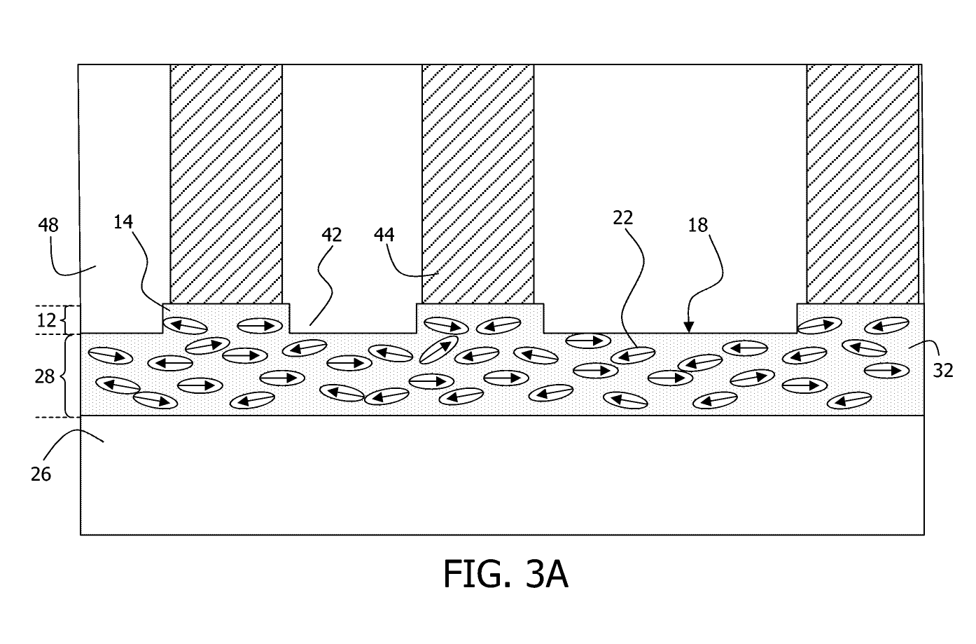

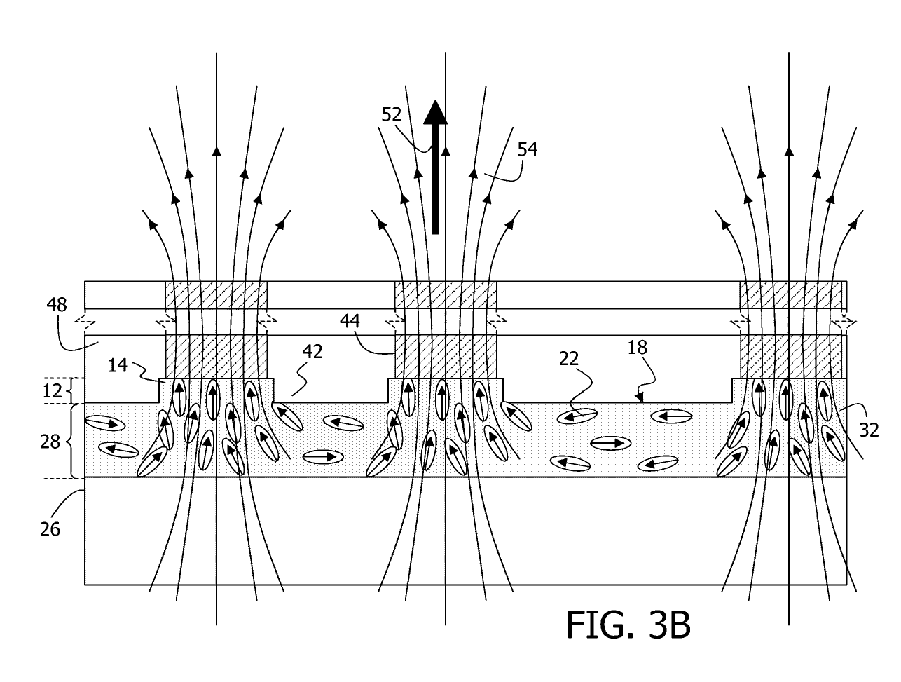

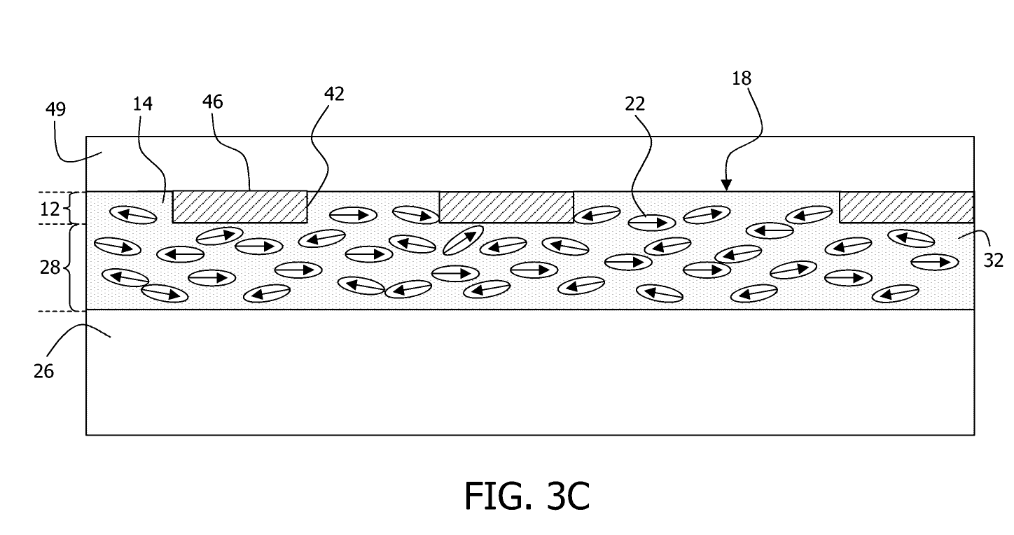

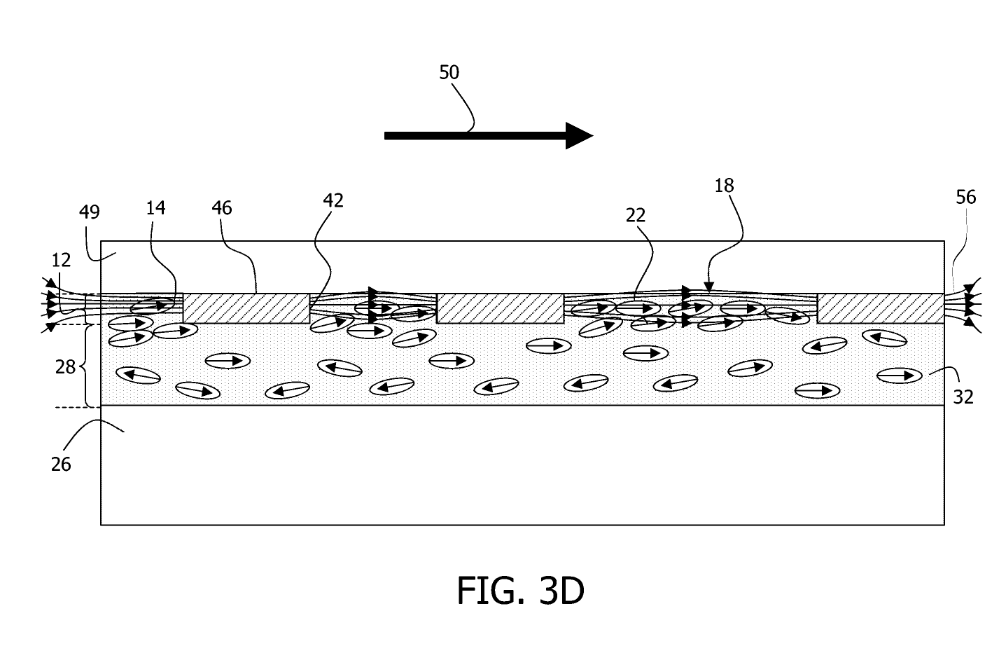

FIGS. 3A to 3D show the utilization of a stamp comprising permeable material in the method of manufacturing the device, and

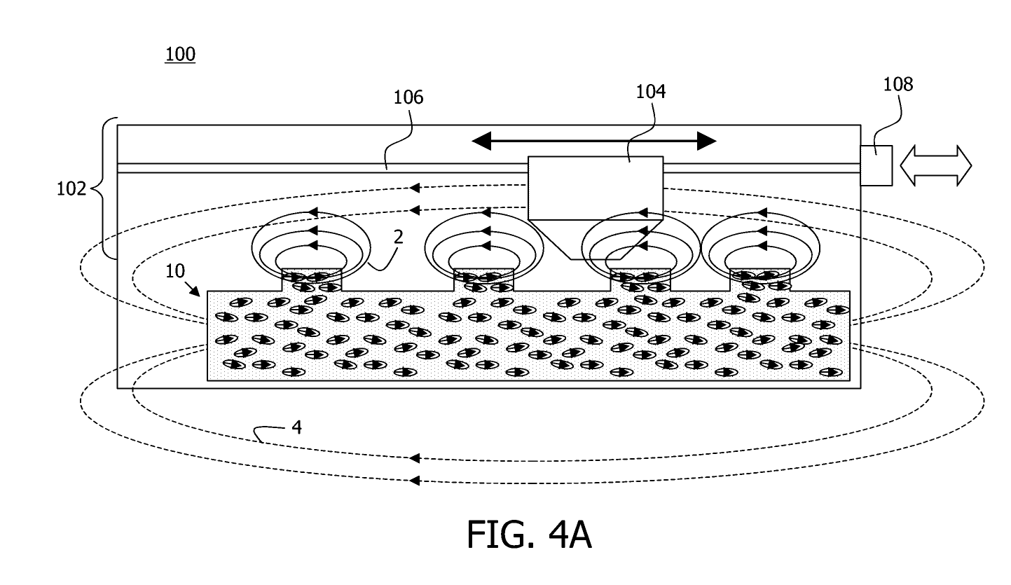

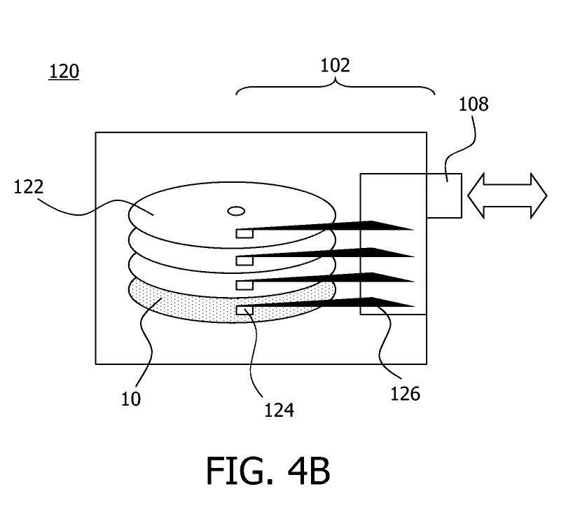

FIGS. 4A and 4B show two embodiments of a storage device according to the invention.

The Figures are purely diagrammatic and not drawn to scale. Particularly for clarity, some dimensions are exaggerated strongly. Similar components in the figures are denoted by the same reference numerals as much as possible.

FIGS. 1A to 1C show embodiments of the device 10, 20, 30 according to the invention. In the embodiments shown in FIGS. 1A to 1C the device 10, 20, 30 comprises magnetic material 18 in which the magnetic material 18 is constituted of particles 22 dispersed in a solid substance 24. The device 10, 20, 30 comprises a layer 12 having disjunct portions 14 of the magnetic material 18. The particles 22 in the solid substance 24 are magnetized particles 22 which are magnetized in the direction indicated by the arrow inside the particles 22. In the embodiments shown, the particles 22 are substantially aligned, for example, using an externally applied magnetic field 50, 52 (see FIGS. 2C, 2D, 3B and 3E). Due to the aligned magnetized particles 22 the magnetic material 18 comprises a macroscopic (relatively weak) magnetic field 4. Inside the layer 12 the disjunct portions 14 are isolated portions of magnetized material 18 which generate local (relatively strong) magnetic fields 2 emerging from the device 10, 20, 30.

In an embodiment of the device 10, 20, 30, the device 10, 20, 30, for example, is a magnetic Read Only Memory device in which the pattern of local magnetic fields 2 represents information stored on the magnetic Read Only Memory device. Each disjunct portion 14 may represent a magnetic bit in which the presence or absence of a disjunct portion 14 generating a local magnetic field 2 may represent a value of a magnetic bit. In a further embodiment the device 10, 20, 30, for example, is part of a biosensor arrangement that requires a pattern of local magnetic fields 2.

Magnetic material 18 comprises particles 22 dispersed in the solid substance 24. The solid substance 24 may be non-permeable material for allowing the particle magnetic fields to add up and generate the local magnetic field 2 emerging from the disjunct portions 14. In a preferred embodiment the solid substance 24 is a polymer which enables the use of a broad range of well known production methods to manufacture the device 10, 20, 30.

Particles 22 dispersed in the solid substance 24 are magnetically stable. Typically the magnetic stability is determined by a barrier energy, which is the energy required to change the magnetization direction of the particle 22. The barrier energy depends on the volume of the particles 22 and on a material parameter called the magnetic anisotropy energy density. It can be readily understood that a reduction of the size of the particles 22 enables a reduction of the size of the disjunct portions 14 in the device 10, 20, 30. Especially when the device 10, 20, 30 is used as a Read Only Memory device, a reduction of the size of the disjunct portions 14 enables an increase in the storage density on the device 10, 20, 30. However a reduction of the size of the particles 22 reduces the barrier energy and when the barrier energy approaches the thermal energy of the particles 22, they become magnetically unstable and randomly change magnetization. Particles 22 constituted of material having a high magnetic anisotropy energy density, for example, a magnetic anisotropy energy density above 100 kilo-Joules per cubic meter enables the reduction of the particle size to below 13 nanometer while the particles 22 retain their magnetic stability for thousands of years. In a preferred embodiment the particles 22 are constituted of material having a magnetic anisotropy energy density of above 400 kilo-Joules per cubic meter, for example, particles 22 constituted of Samarium Cobalt (SmCo). The use of Samarium Cobalt enables the size of the particles 22 to be reduced to below 8,5 cubic nanometer while retaining the magnetic stability for hundreds of years. Magnetic material 18 comprising Samarium Cobalt as the particles 22 dispersed in the solid substance 24 enables disjunct portions 14 having sub-micron dimension which results in a typical storage capacity of 100 Gigabit per square inch.

Due to the alignment of the particles 22 the magnetic material 18 is magnetized. To obtain a substantially permanently magnetized magnetic material 18 the magnetization direction of the particles 22 dispersed in the solid substance 24 must be fixed within the solid substance 24. To achieve this, the particles 22 are chosen to be magnetically stable (see previous paragraph). However, the magnetic stability of the magnetic material 18 also depends on the fixation of the particles 22 in the solid substance 24. For example, when the particles 22 are spherical a rotation of the particles 22 in the solid substance 24 may still be possible. In an embodiment of the device 10, 20, 30, the particles 22 have a shape for securing the alignment of the particles 22 within the solid substance 24. In a further embodiment of the device 10, 20, 30, the particles 22 chemically bond to the solid substance 24 for securing the alignment of the particles 22 within the solid substance 24. Fixation of the alignment of the particles 22 in the solid substance 24 secures the magnetization of the magnetic material 18 and secures the pattern of local magnetic fields 2 in the device 10, 20, 30.

FIG. 1A shows an embodiment of the device 10 in which the magnetic material 18 is provided in a continuous layer 28 and the disjunct portions 14 are constituted by protruding portions 14 from the continuous layer 28.

FIG. 1B shows an embodiment of the device 20 in which an additional cover layer 34 is applied, covering the layer 12 of disjunct portions 14. The cover layer 34, for example, is constituted of non-magnetic material to enable the local magnetic fields 2 to emerge from the device 20.

FIG. 1C shows an embodiment of the device 30 in which the pattern of disjunct portions 14 is directly applied to the substrate 26. The pattern of disjunct portions 14 may, for example, be applied via drops of liquid magnetic material 18 in which the particles 22 are aligned. Subsequent solidification of the drops of magnetic material 18 results in the pattern of disjunct portions 14 of particles 22 dispersed in the solid substance 24.

FIGS. 2A to 2E show several steps in a method of manufacturing the device 10 according to the invention.

FIG. 2A shows a layer 28 of magnetic material 18 applied to a substrate 26 in which the magnetic material 18 is constituted of particles 22 dispersed in a substance 32. The substance 32 typically has a viscosity which allows the particles 22 dispersed in the substance 32 to rotate relatively freely. FIG. 2A also shows a stamp 40 comprising protrusions 42 emerging from the stamp 40. The protrusions 42 from the stamp 40 are arranged in a negative stamp-pattern. The negative stamp-pattern is chosen such that when the stamp 40 is applied to the layer 28 of magnetic material 18 the pattern of disjunct portions 14 is created in the magnetic material 18. The viscosity of the substance 32 which allows the particles 22 dispersed in the substance 32 to rotate, typically also enables the creation of the pattern of disjunct portions 14 in the layer 28 of magnetic material 18 by applying the stamp 40.

FIG. 2B shows the stamp 40 applied to the layer 28 of magnetic material 18, creating a layer 12 having the pattern of disjunct portions 14.

FIG. 2C shows the alignment of the particles 22 dispersed in the substance 32 via an externally applied magnetic field 50. The applied stamp 40 is, for example, constituted of non-permeable material for allowing the externally applied magnetic field 50 to align the particles 22 dispersed in the substance 32. In an embodiment, the stamp 40 is constituted of magnetized permanent magnetic material, providing a pattern of local applied fields to the layer 28 of magnetic material 18. In FIG. 2C the externally applied magnetic field 50 is arranged parallel to the layer 28. The externally applied magnetic field 50 may also be arranged perpendicular to the layer 28 or at a predefined angle with respect to the layer 28 without departing from the scope of the invention.

FIG. 2D shows the step of solidifying the substance 32 to obtain the solid substance 24. The solidification as shown in FIG. 2D is performed by irradiating the substance 32 through the stamp 40 with ultraviolet light UV which, for example, alters the chemical composition of the substance 32. The substance 32, for example, is a monomer which is polymerized when irradiated with ultraviolet light UV to form the solid substance 24 being a polymer. The solidification of the substance 32 will fix the magnetically aligned particles 22 in the solid substance 24 creating a permanently magnetized magnetic material 18. Alternatively the substance 32 may be a hot melted solid substance 24 to obtain increased mobility of the particles 22 during the application of the stamp 40 and during alignment of the particles 22. Subsequently cooling down secures the pattern of disjunct portions 14 in the magnetic material 18 and secures the aligned particles 22 in the solid substance 24. An additional benefit when using the substance 32 having an increased temperature is that the increase in temperature avoids clustering of particles 22 because of increased thermal agitation.

FIG. 2E shows the device 10 as produced according to the shown process steps. Because the disjunct portions 14 protrude from the continuous layer 28 of magnetic material 18, local magnetic fields 2 are created.

Modifications of the steps shown in FIGS. 2A to 2E may be performed without departing from the scope of the invention. For example, the externally applied magnetic field may be present during any one of the steps shown in FIGS. 2A to 2D. Especially applying the externally applied magnetic field 50 during the solidification process ensures the alignment of the particles 22 during the solidification process. Another modification may be to remove the stamp 40 before the substance 32 is solidified. The magnetic material 18, for example, comprises a viscosity through which the pattern of disjunct portions 14 remains present in the layer 12 even when the stamp 40 is removed. The benefit of this modification is that the stamp 40 does not need to be transparent for the ultraviolet light UV. Also modification in the step of solidification is possible without departing from the scope of the invention, for example, solidification via oxidation, two-component blending, thermal curing, or cooling. The type of solidification depends on the substance 32 used.

In the embodiments shown in FIGS. 2C to 2E the particles 22 in the magnetic material 18 are all substantially aligned. In an alternative embodiment (not shown) the alignment of the particles 22 in, for example, a disjunct portion 14 may be one of a plurality of predefined magnetic field directions. This may be achieved by locally reducing the viscosity of the solid substance 24, for example, by local heating of the solid substance 24 and applying an external magnetic field 50 corresponding to the required local magnetization direction. Subsequent increase of the viscosity, for example, by cooling the solid substance 24 secures the local magnetization direction of the disjunct portion 14. Alternatively the plurality of predefined magnetic field directions may be achieved by local solidification. For example, a first mask (not shown) is applied between the ultraviolet light UV and the magnetic material 18 which transmits the ultraviolet light UV only at predetermined disjunct portions 14 while a first externally applied magnetic field (not shown) is present. A second mask (not shown) replaces the first mask and transmits the ultraviolet light UV only at alternative disjunct portions 14 while a second externally applied magnetic field (not shown) is present. The magnetization direction of the first externally applied magnetic field is distinct from the magnetization direction of the second externally applied magnetic field. The pattern of local magnetic fields 2 comprising a plurality of predefined magnetic field directions may be sensed using a sensor which is sensitive to differences in magnetic field direction. When the device comprising a plurality of predefined magnetic field directions is used as a Read Only Memory device a specific magnetic field direction sensed by the sensor may represent a specific value of the information stored on the device.

In an alternative embodiment of the method of manufacturing the device 10, the step of solidifying the substance 32 comprising aligned particles 22 is performed before the step of creating the pattern of disjunct portions 14. The pattern of disjunct portions 14 are, for example, protrusions from the solid substance 24 created via, for example, etching the solid substance 24. Typically etching of the solid substance 24 can be done via well known lithography methods in which a resist may be applied to the solid substance 24. Creating, for example, a resist-pattern corresponding to the required pattern of disjunct portions 14 enables the etching of the solid substance 24 to obtain the pattern of disjunct portions 14.

FIGS. 3A to 3D show the utilization of a stamp 48, 49 for manufacturing the device in which the stamp 48, 49 comprises a pattern of magnetically-permeable material 44, 46. Magnetically permeable material 44, 46 typically gathers magnetic lines of force. Applying the magnetically permeable material 44, 46 in a pattern creates spatial magnetic field strength variations 54, 56. The pattern of permeable material 44, 46 within an externally applied magnetic field 50, 52 enables a focusing of the magnetic field, for example, in the disjunct portions 14. When focusing the magnetic field 50, 52 in the disjunct portions 14, the magnetic field strength of the externally applied magnetic field 50, 52 can be reduced while still the magnetic field strength at the disjunct portions 14 is sufficient to align the particles 22 in the disjunct portions 14. An additional benefit focusing the externally applied magnetic field 50, 52 in the disjunct portions 14 is that this enables a concentration variation of the particles 22 in the magnetic material 18. Magnetized particles 22 tend to minimize their magneto-static energy and therefore are drawn toward the focused magnetic field 54, 56 at the disjunct portions 14. When the mobility of the magnetized particles 22 is high enough the focusing of the magnetic field 54, 56 in the disjunct portions 14 will increase the density of the magnetized particles 22 at the edges of the disjunct portions 14, increasing the strength of the resulting local magnetic fields 2.

FIG. 3A shows the creation of the pattern of disjunct portions 14 in which a stamp 48 is used having a pattern of magnetically-permeable material 44 which corresponds to the pattern of disjunct portions 14. FIG. 3B shows the spatial magnetic field strength variation 54 due to the pattern of permeable material 44 which occurs when the external magnetic field 52 is applied (in FIG. 3B the stamp 48 is reduced in height to shown the spatial field strength variation 54). As can be seen from the FIG. 3B, a concentration increase of particles 22 is shown at the disjunct portions 14 resulting from a migration of the particles 22 due to the focused magnetic field strength variations 54. Preferably the dimensions of the permeable material 44 perpendicular to the layer 28 must be larger than the dimensions of the permeable material 44 parallel to the layer 28.

FIG. 3C shows the creation of the pattern of disjunct portions 14 in which a stamp 49 is used having permeable material 46 arranged at the protrusions 42 emerging from the stamp 49. In an embodiment of the stamp 49 the protrusions 42 may be formed fully from permeable material 46. FIG. 3D schematically shows the spatial magnetic field strength variation 56 due to the pattern of permeable material 46 which occurs when the external magnetic field 50 is applied. In this embodiment the spatial magnetic field strength variation 56 focuses the externally applied magnetic field 50 in the layer 12 comprising the disjunct portions 14 increasing the strength of the magnetic field at the disjunct portions 14. Shown in FIG. 3D is that the presence of a focused magnetic field in the layer 12 comprising the disjunct portions 14 creates an increased concentration of the particles 22 in the substrate 32 at the disjunct portions 14 compared to the remainder of the magnetic material 18.

In an alternative embodiment the pattern of permeable material 44, 46 may be applied separate from the stamp 48, 49, for example, using a mask (not shown) constituted of non-permeable material having the pattern of permeable material 44, 46. The mask of permeable material 44, 46 may be applied during the step of aligning the particles 22, for example, after the stamp 40 has been applied for creating the pattern of disjunct portions 14.

FIGS. 4A and 4B show two embodiments of a storage device according to the invention. FIG. 4A shows the storage device 100 comprising a device 10 being a Read Only Magnetic information carrier 10 and a read out part 102. The read out part 102 comprises a sensor 104, a scanning system 106 and an input/output device 108. The read out part 102 comprises, for example, a motor for rotating the Read Only Magnetic information carrier 10 across the sensor 104, or, for example, a rail 106 for scanning the sensor 104 across the Read Only Magnetic information carrier 10, or, for example, a rail for scanning the Read Only Magnetic information carrier 10 across the sensor 104. The sensor 104, for example, senses the local magnetic fields 2 of the disjunct portions 14 through the magneto-resistance phenomenon in which the local magnetic field 2 determines a resistance in the sensor 104. The sensor 104, for example, moves along the scanning system 106 and senses the presence or absence of the local magnetic fields 2 by scanning across the disjunct portions 14 of the Read Only Magnetic information carrier 10. The sensor 104, for example, may also be sensitive to the direction of the local magnetic field 2. In the example shown in FIG. 4A, the scanning system 106 is also used to provide the data retrieved by the sensor 104 to an input/output device 108. Via the input/output device 108, the data read from the Read Only Magnetic information carrier 10 can be provided to any other electronic equipment, such as, a personal computer, a video game, a mobile phone, etc.

FIG. 4B shows a storage device 120 according to the invention, being a hard-disc drive 120. The hard-disk drive 120 comprises a plurality of storage platters 122 for storing information and a plurality of arms 126 each comprising a read-write head 124. The hard-disk drive 120 comprises a device 10 according to the invention being a Read Only Magnetic information carrier 10. Because the information stored on the device 10 is represented by the pattern of local magnetic fields 2, the information can be read by the read-write head 124 of the hard-disk drive 120.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A method of manufacturing a device comprising a layer having a pattern of disjunct portions of magnetic material generating a corresponding pattern of local magnetic fields, the magnetic material being constituted of particles dispersed in a solid substance, the particles being magnetically stable and substantially aligned for generating the local magnetic fields, the method comprising the steps of:
providing a substance having the particles dispersed in the substance, the substance having a viscosity for allowing the particles to move in the substances,
creating the pattern of disjunct portion of the substance in the layer of the device,
applying an external magnetic field for substantially aligning the particles in the disjunct portions of the substance,
solidifying the substance for obtaining the solid substance.

2. A method of manufacturing the device as claimed in claim 1, wherein the step of applying the external magnetic field is performed during the step of solidifying the substance.

3. A method of manufacturing the device as claimed in claim 1, wherein the step of applying the external magnetic field comprises creating spatial magnetic field strength variations in the external magnetic field.

4. A method of manufacturing the device as claimed in claim 3, wherein the step of applying the external magnetic field is performed during the step of creating the pattern of disjunct portions and wherein the step of creating the pattern of disjunct portions comprises utilizing a stamp for creating the pattern of disjunct portions, the stamp comprising magnetically permeable material for creating the spatial magnetic field strength variations.

5. A method of manufacturing the device as claimed in claim 4, wherein the magnetically permeable material of the stamp is arranged in a stamp-pattern corresponding to the pattern of disjunct portions.

6. A method of manufacturing the device as claimed in claim 4, wherein the magnetically permeable material of the stamp is arranged in protrusions emerging from the stamp and being arranged in a negative stamp-pattern for creating the pattern of disjunct portions.

7. A method of manufacturing the device as claimed in claim 1, wherein the step of providing the substance comprises providing the substance in a continuous layer and wherein the step of creating the pattern of disjunct portions comprises creating protrusions from the continuous layer, the protrusions being the disjunct portions.

8. A method of manufacturing the device as claimed in claim 1, wherein the step of providing the substance comprises providing a monomer as the substance and wherein the step of solidifying the substance comprises polymerizing the monomer to obtain a polymer.

9. A device comprising a layer having a pattern of disjunct portions of magnetic material generating a corresponding pattern of local magnetic fields, the magnetic material being constituted of particles dispersed in a solid substance, the particles being magnetically stable and substantially aligned for generating the local magnetic fields.

10. A device as claimed in claim 9 being a read only magnetic information carrier, wherein the pattern of local magnetic fields represents information stored on the read only magnetic information carrier.

11. A device as claimed in claim 9, wherein the particles are constituted of material having a magnetic anisotropy energy density of at least 100 kilo-Joules per cubic meter and preferably above 400 kilo-Joules per cubic meter.

12. A device as claimed in claim 9, wherein the local magnetic fields substantially all have a same magnetic field direction.

13. A device as claimed in claim 9, wherein the solid substance is a polymer.

14. A device as claimed in claim 9 being a storage device comprising a read-out, the read-out part comprising a sensor for sensing the pattern of local magnetic fields.
